(19) United States
(12) Patent Application Publication
(10) Pub. No.: US 2016/0092085 A1
(43) Pub. Date: Mar. 31, 2016

(54) SELECTIVE ACCESS TO INTERACTIVE DEVICE FEATURES

(71) Applicant: Intel Corporation, Santa Clara, CA (US)

(72) Inventors: Kathi R. Kitner, Hillsboro, OR (US); Rita H. Wouhaybi, Portland, OR (US)

(21) Appl. No.: 14/498,706

(22) Filed: Sep. 26, 2014

(51) Int. Cl. G06F 3/0484

(52) U.S. Cl. CPC G06F 3/04847; G06F 3/04842

(57) ABSTRACT

Methods, computer-readable media, and apparatuses for providing access to interactive features to a user of a computing device are described. The computing device may determine a level of interactive facility for the user and to selectively provide access to one or more interactive features. The computing device may determine new levels of interactive facility, such as through an evaluation of the user and/or based on various interactions with the computing device. The computing device may identify requests for interactive features and/or levels of frustration or comfort to determine levels of interactive facility with the computing device. The computing device may selectively hiding or making available interactive features to the user. The computing device may announce when features are made available such as through visual or auditory announcements. Other embodiments may be described and/or claimed.

### TECHNICAL FIELD

The present disclosure relates to the field of data processing, in particular, to apparatuses, methods and storage media associated with selectively providing access to interactive features of devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Many computing device environments provide a wealth of activities and interactive features for their users. Users may play music or other media, browse websites and other internet information repositories, obtain weather and traffic information, shop for content and other items, communicate with other users via text, voice, or video, etc. However, these interactive features may not always be apparent or understandable to a user. In particular, users who are not used to a particular device or a particular operating system or ecosystem, may have a very difficult time discovering and utilizing the interactive features that are available to them on various devices. Additionally, users that are uncomfortable with their devices may be more likely to accidentally install malicious software, further degrading the experience of using the device. These difficulties can lead to inefficient usage of the device, where features are ignored or deliberately avoided for fear of the user doing something wrong. In some circumstances, users may be made uncomfortable by the various interactive features of their devices, and may actively avoid use of the device entirely which is a sub-optimal scenario.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example of providing selective access to interactive features of a computing device in accordance with various embodiments.

FIGS. 2a and 2b illustrate an example arrangement for a computing device configured to selectively provide access to interactive features in accordance with various embodiments.

FIG. 3 illustrates an example process for selectively providing access to interactive features in accordance with various embodiments.

FIG. 4 illustrates an example process for setting up a device for use by a user, in accordance with various embodiments.

FIG. 5 illustrates an example process for determining a level of user facility, in accordance with various embodiments.

FIG. 6 illustrates an example process for providing access to features in accordance with various embodiments.

FIG. 7 illustrates an example computing environment suitable for practicing various aspects of the present disclosure in accordance with various embodiments.

FIG. 8 illustrates an example storage medium with instructions configured to enable an apparatus to practice various aspects of the present disclosure in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. As described herein, the term “logic” and “module” may refer to, be part of, or include a System on a Chip, as described below.

In various embodiments, a computing device may be configured to perform one or more techniques described herein to selectively provide access to interactive features to a user. In various embodiments, the interactive features may be provided by one or more application modules, as described herein. In various embodiments, the computing device may be configured to determine a level of interactive facility for the user with the computing device. Based on this determined level, the computing device may be configured to selectively provide access to one or more interactive features of the computing device.

In various embodiments, the computing device may be configured to determine new levels of interactive facility as the user uses the computing device. In various embodiments, the computing device may be configured to determine an initial level of interactive facility through an evaluation of the user, such as through a questionnaire. In various embodiments, the computing device may be configured to determine the level of interactive facility based on various interactions the user has with the computing device. These interactions may include, but are not limited to, taps, drags, holds, entered text, voice commands, etc. In various embodiments, the computing device may be configured to identify requests for interactive features (including both explicit and implicit requests) and/or levels of frustration or comfort with a current set of interactive features and may use these determinations to determine levels of interactive facility with the computing device. In various embodiments, the computing device may be configured to determine levels of interactive facility based on a profile for the user. The profile may be associated with one or more groups or demographic details of the user. The profile may also include other devices that the user owns currently, has owned in the past, or may otherwise have access to.

In various embodiments, the computing device may be configured to selectively provide access to interactive features by selectively hiding or making available interactive features to the user. In some embodiments, the computing device may be configured to announce when features are made available such as through visual or auditory announcements. In some embodiments, the computing device may be configured to allow a user to hide one or more interactive features that have previously been made available.

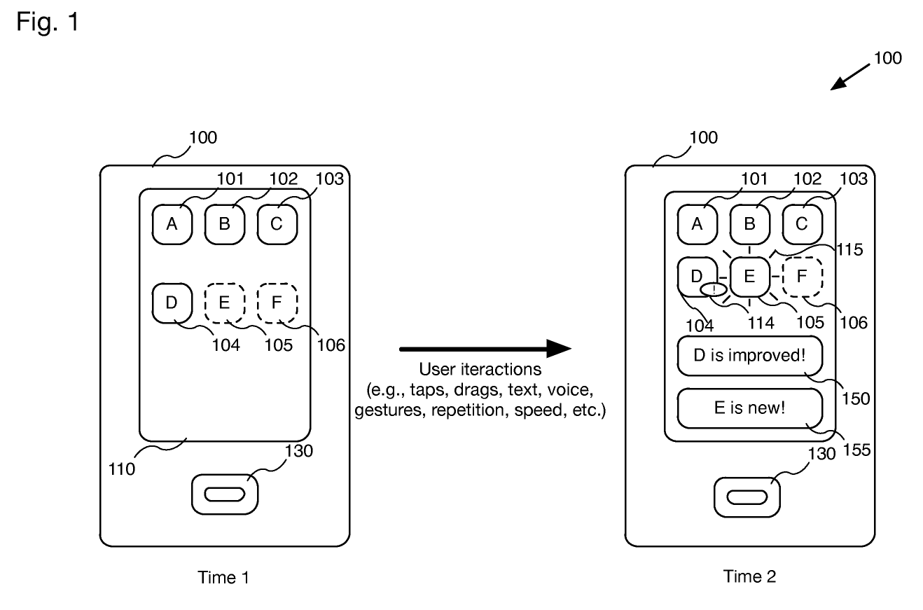

Referring now to FIG. 1, an example 100 of providing selective access to interactive features of a computing device 100 is illustrated in accordance with various embodiments. In the example of FIG. 1, the computing device 100 has been configured to modify access to various provided interactive features between a first time and a second time based on various user interactions. It may be recognized that, while the example of FIG. 1 includes particular examples of interactive features, provision of access to the features, and user interactions, these are provided solely as examples, and should not be read as implying any particular limitations to embodiments described herein.

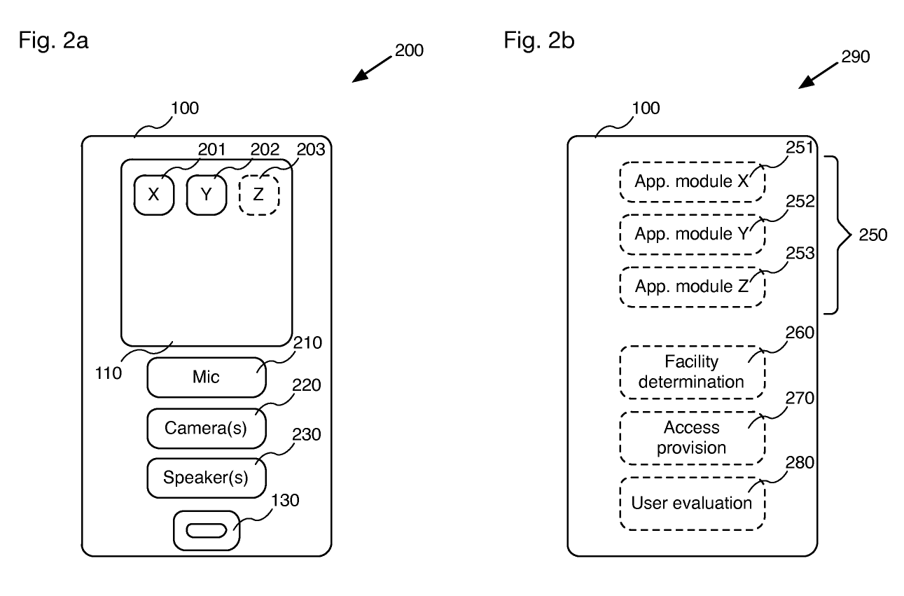

In various embodiments, the computing device 100 may include various types of mobile or non-mobile computing devices, including, but not limited to, mobile phones, tablet computers, media players, laptop computers, desktop computers, wearable devices, etc. In various embodiments, the computing device 100 may provide access to one or more interactive features, such as interactive features of displayed applications 101-104. In various embodiments, these interactive features may be provided on a display of the computing device 100, such as the example touchscreen 110. In various embodiments, these interactive features may be provided through activities of one or more application modules, as described below with reference to FIG. 2.

In various embodiments, interactive features of the computing device may include various modes of interaction between a user and the device, including, but not limited to, web browsing, search features, game features, reference features, content playback, content recording, facilities to install applications or other software, access to device settings, etc. In the example of FIG. 1, the various interactive features are represented using icons for applications 101-104, for the sake of ease of illustration. However, it may be recognized that interactive features described herein, as well as access thereto, may be considered to occur at various levels of granularity, and that access may be provided at these different levels of granularity. Thus, in various embodiments, providing access to an interactive feature may include providing access to an entire application that is installed (or otherwise made available) on the computing device 100. In other embodiments, providing access to an interactive feature may include providing access to one or more particular interactive features of an application on the computing device 100.

As discussed above, in various embodiments, the computing device 100 may be configured to selectively provide access to various interactive features. Thus, in various embodiments, the computing device 100 may be configured to only provide access to a subset of those features that may be available to the device. In the example of FIG. 1, the computing device 100 is configured such that, at Time 1, it can provide access to interactive features of applications 101-106, but is currently only providing access to interactive features of applications 101-104. In various embodiments, the features for which access is not currently provided to a user (e.g. interactive features of applications 105 and 106) may not be displayed to a user. In other embodiments, the interactive features may be displayed as inactivated, such as in a dimmed, outlined, or ghosted form (as illustrated in FIG. 1).

In various embodiments, the computing device 100 may be configured to provide access to interactive features based on interactions between a user and the computing device 100. In various embodiments, the computing device 100 may base provision of access to interactive features on touch-based or gestural interactions, such as taps, holds, drags, pinches, etc. These may be performed, in various embodiments, on touch-sensitive potions of the computing device 100, such as the illustrated touchscreen 110, or on other touch- or pressure-activated elements, such as button 130. In various embodiments the computing 100 may also base provision of access to interactive features on information that has been entered or otherwise provided to the computing device 100. For example, the computing device 100 may base such provision on text entered into the device, such as in search fields, reference applications, help screens, etc. In various embodiments, the computing device 100 may base provision of access to interactive features on other forms of input, such as, but not limited to, voice input, detection of motion or gestures made using the computing device 100, detection of motion or gestures made by hands or other objects in the vicinity of the computing device 100, etc. In various embodiments, the computing device may also be configured to base provision of access to interactive features on a manner in which an interaction is performed, such as a speed in which an interaction is performed (e.g. fast, slow, tentative, etc.), or a number of repetitions performed (such as if a user repeatedly taps a user interface element out of frustration) and/or progress of the user in learning and using a feature.

In various embodiments, as described herein, the computing device 100 may be configured to provide new or modified access to interactive features. In various embodiments, access to integrative features may be provided by making new applications available to a user. In other embodiments, access to interactive features may be provided modifying access to an application such that additional functionality that was previously unavailable is now made available to users. Thus, in the illustrated example, at Time 2, the computing device 100 has, based on user interactions, made application 105, which was previously unavailable, available to the user. Similarly, the computing device has, at Time 2, added access to a previously unavailable interactive feature of application 104.

In various embodiments, the computing device 100 may be configured to provide an indication to the user that access to interactive features is provided. In some embodiments, the computing device may be configured to modify an icon or other graphical element of an application (or other software service) such that the user is aware of the provided access. For example, in the illustrated example of FIG. 1, at Time 2, a warning badge 114 has been attached to the icon for application 104. Also in the example of FIG. 1, at Time 2, lines have been added around the icon for application 105 in order to illustrate that it has newly become available. It maybe noted, however, that application 106 remains unavailable to the user in the example of FIG. 1; thus, in various embodiments, interactive features may be selectively made available by the computing device, according to techniques described herein. Additionally, in various embodiments, the computing device may be configured to display one or more messages to a user in order to inform them that access to interactive features has been provided or modified. Thus, in the example of FIG. 1, at Time 2 the computing device 100 has displayed a message 150 that access to new interactive features has been provided in application 104 (e.g., “D is improved!”). Similarly, at Time 2 the computing device 100 has displayed a message 155 that application 105 has been made available (e.g., “E is new!”).

Referring now to FIGS. 2a and 2b, respective example arrangements 200 and 290 for a computing device configured to selectively provide access to interactive features are illustrated in accordance with various embodiments. In various embodiments, the computing device 100 may be configured to include various hardware and/or software-based interactive elements, through which the computing device 100 may receive interactions from a user. For example, as discussed above, and as illustrated in FIG. 2a, in various embodiments, computing device 100 may be configured with a touchscreen 110, through which one or more users may interact with the computing device. As may be understood, in various embodiments, a user may interact with the touchscreen using various touch-based methods, such as tapping, dragging, pinching in and out, holding, etc. Additional touch-based interaction may be provide with the use of one or more other touch- or pressure-based interactive elements, such as button 130. In various embodiments, the touchscreen 110 may be utilized to display applications or other software with one or more interactive features, such as applications 201-203.

In various embodiments, the computing device 100 may also include a microphone 210, through which the computing device 100 may receive sound- or voice-based interaction from a user. In various embodiments, the computing device 100 may include one or more camera(s) 220, though which the computing device 100 may record image or video data. In various embodiments, the computing device 100 may be configured to receive image and/or video data recorded by the one or more camera(s) 220 to receive gestural interactions from a user. In various embodiments, the computing device 100 may also be configured to receive image and/or video data recorded by the one or more camera(s) 220 to detect facial feature information to use when determining a user's level of comfort with usage of the computing device 100. Additionally in various embodiments, the computing device may include one or more speaker(s) 230, through which the computing device 100 may play sound. In various embodiments, the computing device 100 may be configured to utilize the one or more speaker(s) 230 to provide audio cues to a user, such as when providing access to one or more interactive features. In various embodiments, the hardware elements described above to provide for receiving user interaction may be implemented according to techniques known by those of ordinary skill.

As illustrated in the example of FIG. 2b, in various embodiments, the computing device 100 may also be configured to include one or more modules configured to perform the techniques described herein. In various embodiments, these modules may be implemented in hardware, software, or combinations thereof. Additionally, it may be recognized that the particular modules illustrated in FIG. 2b are provided for sake of example only, and that, in various embodiments, the described modules may be combined, separated into additional modules, and/or eliminated entirely.

In various embodiments, the computing device 100 may include on or more application modules 250 (e.g., application modules 251-253) which may be configured to provide interactive features of the computing device 100. Thus, in the examples of FIGS. 2a and 2b, the applications 201-203 may be implemented through execution of application modules 251-253 on the computing device. It maybe recognized, however, that in various embodiments, applications may or may not be installed directly on the computing device itself. In various embodiments an application module 250 may reside, for example, on the computing device itself, on another computing device, on a server, or in a cloud-based entity. In various embodiments, application modules 250 may include application modules executing in various environments, such as executing natively on the computing device, in a virtualized environment on the device, and/or in a remote environment. In various embodiments, application modules 250 may include, but are not limited to: application modules natively executing on the computing device, application modules executing in a virtual environment, plug-ins, extensions, web-based applications (running on server or distributed amongst multiple devices), etc. Additionally, in various embodiments, an application module 250 may be configured to execute only a portion of the activities of an application or service it may be associated with. Thus, in some embodiments, the computing device may provide access to new interactive features in an application that is already being used on the computing device by installing or otherwise providing access to an application module 250 associated with those particular interactive features.

In addition to application modules 250, in various embodiments, the computing device 100 may include one or more modules which operate to support provision of access to interactive features as described herein. For example, the computing device 100 may include a facility determination module 260 (“FD 260”), which may be configured to determine a level of interactive facility of a user with the computing device. In various embodiments, the term interactive facility may include various metrics for the user's abilities to utilize interactive features of the device, including, but not limited to: a user's level of comfort with utilizing the device, an error rate for use of the device, a number or relative amount of available interactive features of the computing device that are used by the user, a number or relative amount of interactive features explicitly requested for use by the user, etc. In various embodiments, the FD 260 may determine a level of interactive facility based, in whole or in part, on a user's individual interactions with the device. In various embodiments, the FD 260 may be configured to utilize a profile for the user, such as based on demographic or experiential data, to determine the user's level of interactive facility with the computing device. In various embodiments, such a profile may be based on other users that have similar demographics or experience to the user. In various embodiments, the FD 260 may be configured to follow a path associated with a profile, which may describe an ordering of interactive features that may be accessed by the user as the user gains experience. In various embodiments, the FD 260 may be configured to download a profile from a central profile repository (not illustrated). In such embodiments, the computing device 100 may be able to be used by multiple user such that different users may have different experiences according to their profiles. In various embodiments, the computing device may thus be configured to transition between usage by a first user to usage by a second user by providing interactive features according to the profile of the second user, without providing access to interactive features accessible according to the profile of the first user. Additionally, in various embodiments, these transitions may be performed without uninstalling interactive features accessible according to the profile of the first user.

In various embodiments, the computing device 100 may also include a user evaluation module 280 (“UE 280”), which may be configured to evaluate the user to determine an initial level of interactive facility. In various embodiments the UE 280 may be configured to provide a questionnaire for completion by a user to determine the initial level of interactive facility of the user. In various embodiments, the UE 280 may also be configured to request that the user interact with the computing device 100 in order to gauge an initial interactive skill level of the user. In various embodiments, the UE 280 may determine a profile for the user based on the questionnaire and skill level determination; it is this profile that may be used by the FD 260 during later interaction by the user.

In various embodiments, the computing device 100 may include an access provision module 270 (“AP 270”), which may be configured to selectively provide access to the user to interactive features based on the determined level of interactive facility. In various embodiments, the AP 270 may be configured to provide access to existing, installed applications (or interactive features thereof). In various embodiments, the AP 270 may be configured to install or unlock application modules 250 or interactive features of applications that were not previously installed or available on the computing device 100. In various embodiments, the AP 270 may be configured to provide visual or audio indicators, such as those described above, to indicate new interactive features for which access was not previously provided to the user.

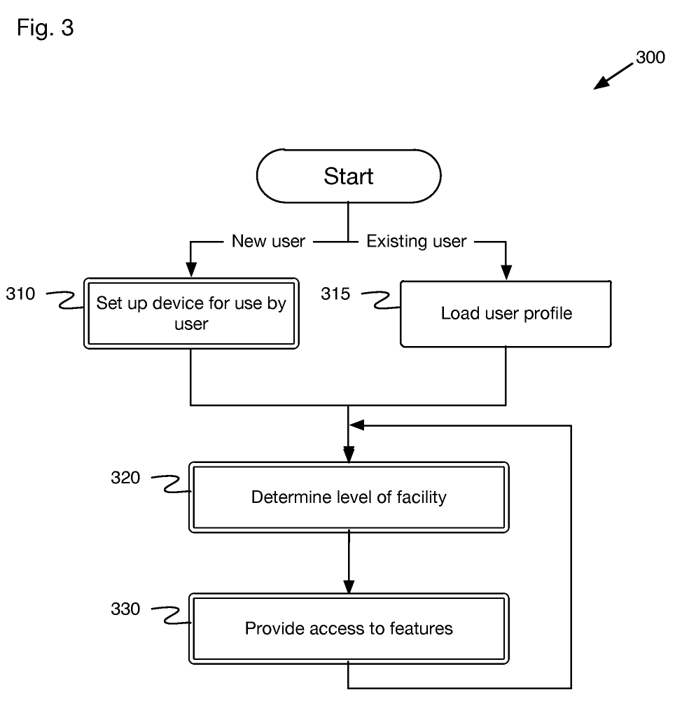

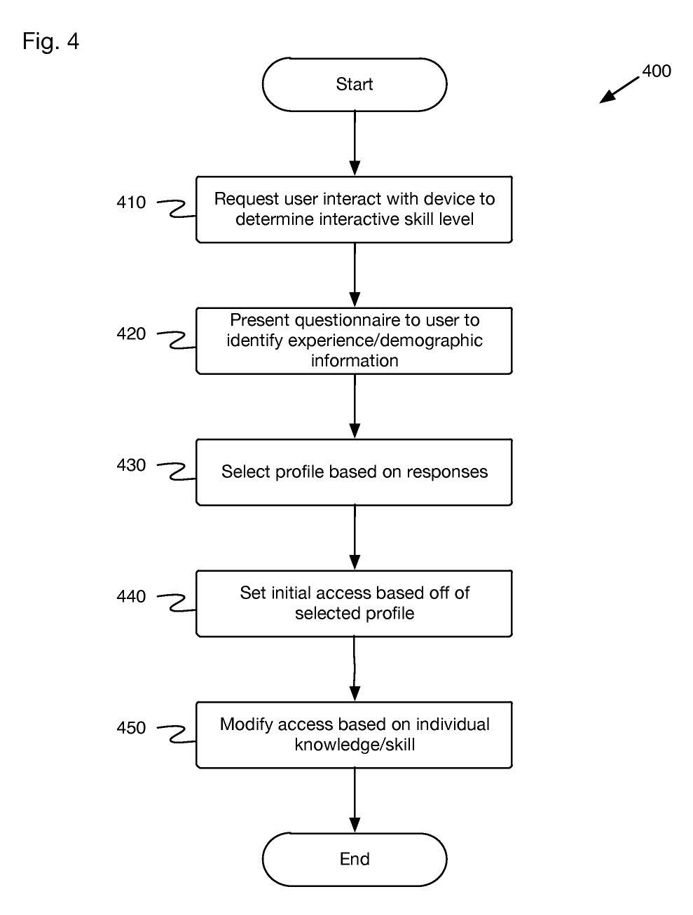

FIG. 3 illustrates an example process 300 for selectively providing access to interactive features in accordance with various embodiments. While FIG. 3 illustrates particular operations in a particular order, in various embodiments the operations may be combined, split into parts, and/or omitted. In various embodiments, operations of process 300 (as well as sub-processes) may be performed by the computing device 100 as well as modules described herein, including the FD 260, AP 270, and UE 280. In other embodiments, operations may be performed by different entities. In various embodiments, the process may begin differently for a new user of the computing device 100 (or for other, similarly-configured computing devices 100) or for an existing user. If the user is new, then the process may begin at operation 310, where the UE 280 and FD 260 may set up the computing device 100 for use by the user. In various embodiments, at operation 310, the UE 280 may obtain information from the user in order to determine an initial level of interactive facility of the user with the computing device 100, and may determine an initial set of interactive features to which the user may be provided access. Particular embodiments of operation 310 are described below with reference to process 400 of FIG. 4.

If the user is an existing user of the computing device 100 or of a similarly-configured computing device 100, then at operation 315, the computing device 100 may load a profile for the user in order to facilitate provision of access to interactive features. In various embodiments, the profile may be downloaded from a central profile repository, as discussed above.

In various embodiments as well, if the user is not an existing user but does not wish to utilize the provision of interactive features described herein, the computing device may present a pre-determined set of interactive features to the user, including, but not limited to, all available interactive features, only basic phone or device features, or some other predetermined subset of features.

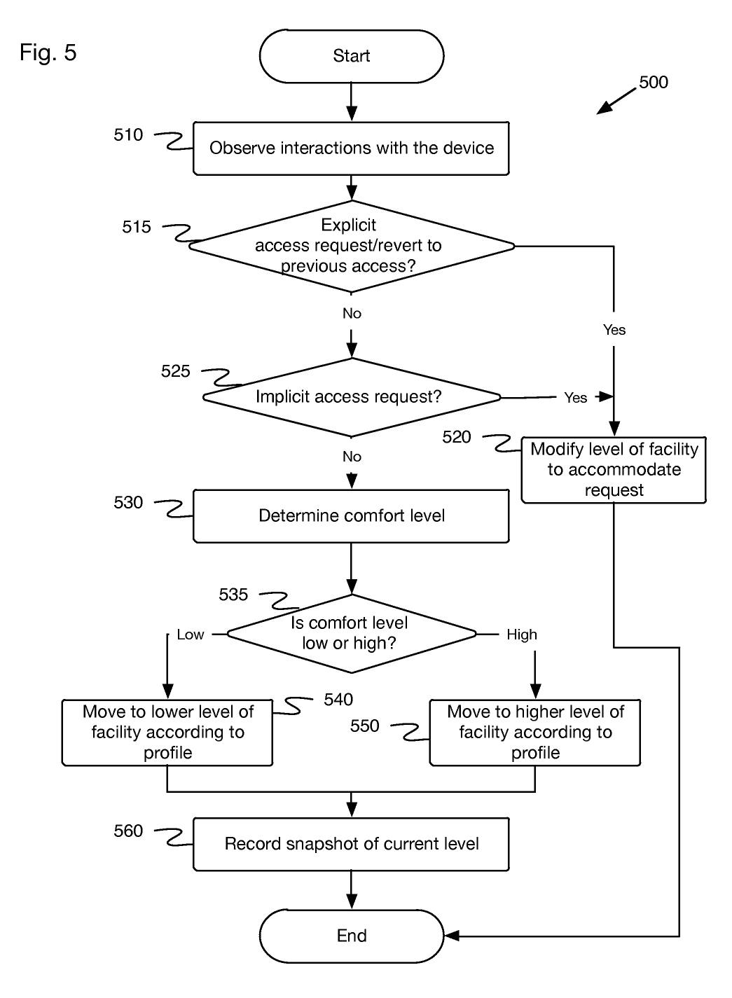

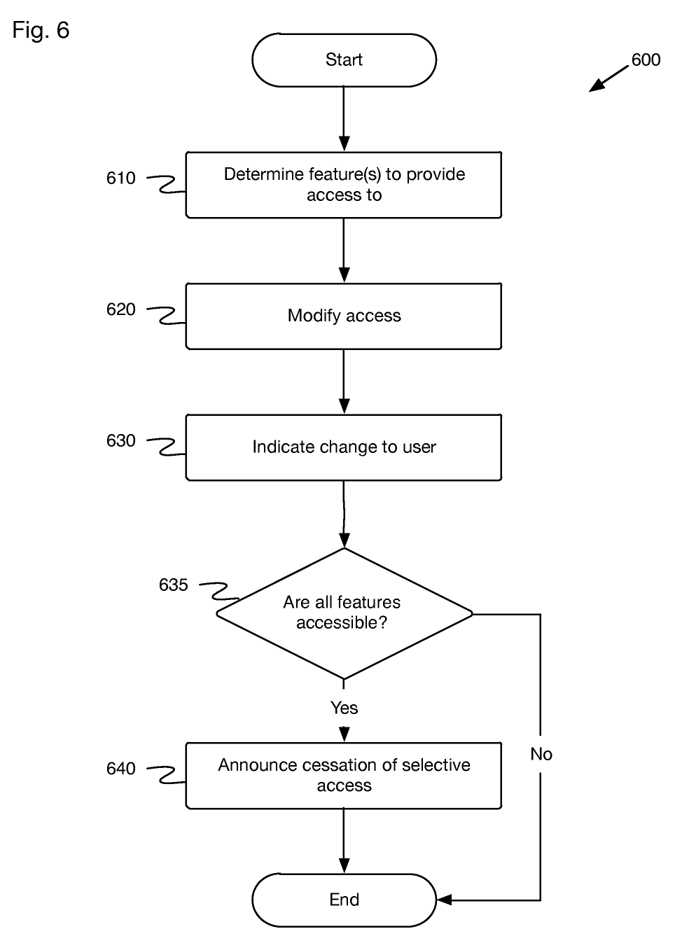

Next, at operation 320, the computing device 100, and in particular the FD 260, may determine a level of interactive facility of the user with the computing device 100. In various embodiments, this determination may be based, on one or more user interactions with the computing device 100 by the user. In various embodiments, the determination may be based on a profile associated with the user. Particular embodiments of operation 320 are described below with reference to process 500 of FIG. 5. Next, at operation 330, the computing device 100, and in particular the AP 270, may provide access to one or more interactive features of the computing device 100. In various embodiments this provision of access may include announcements or other indications to the user of interactive features for which access is being provided. Particular embodiments of operation 330 are described below with reference to process 600 of FIG. 6. After performance of operation 330, process 300 may repeat at operation 320. Thus, in various embodiments, the process may repeatedly determine levels of interactive facility and provide access to the user to interactive features. Through this iterative process, the techniques described herein may provide for an adaptable experience for the user, where the computing device, over time, gradually adapts to the abilities and comfort level of the user, and provides the user with new experiences and features. It may be noted that while the process illustrated in FIG. 3 appears to be a simple, regular loop for ease of illustration, in various embodiments, the process may not proceed with any particular periodicity, and the computing device may hold at provision of any set of interactive features for an indefinite period of time. Such as determination to hold at a particular set of features may be based on user preference or a determination that a level of interactive facility has been maintained.

FIG. 4 illustrates an example process for setting up a device for use by a user, in accordance with various embodiments. Process 400 may include one or more implementations of operation 310 of process 300. While FIG. 4 illustrates particular operations in a particular order, in various embodiments the operations may be combined, split into parts, and/or omitted. In various embodiments, operations of process 400 may be performed by the computing device 100 as well as modules described herein, including the UE 280. In other embodiments, operations may be performed by different entities. The process may begin at operation 410, where the UE 280 may request that a user interact with the computing device 100 to determine an interactive skill level. In various embodiments, the UE 280 may be configured to request that the user perform a series of pre-determined activities to test the skill level. For example, the UE 280 may request that the user perform one or more touchscreen or mouse-based activities, such as tapping, dragging, pinching, scrolling, etc. In other embodiments, the UE 280 may request that the user perform one or more activities where the user utilizes interactive features of the computing device 100. For example, in various embodiments, the UE 280 may request that the user perform a search for information, play a piece of content, look up weather or sports information, change settings for the computing device, etc.

Next, at operation 420, the UE 280 may present a questionnaire to the user to identify experiential and/or demographic information. In various embodiments, such experiential information may include, but is not limited to, the user's length of time owning or using the computing device 100 or other devices, a number of other devices used in the past by the user, the user's self-perceived level of comfort or skill with one or more activities, etc. In various embodiments, the demographic information may include, but is not limited to, geographical location of the user, occupation of the user, age, race, sex, gender, income level, etc. In various embodiments at operation 420, the UE 280 may also ask the user to identify one or more interests that the user has.

Next, at operation 430, the UE 280 may select a profile to associate with the user based on the responses provided at operation 420. In various embodiments, the profile may be selected based on particular demographics the user shares with other users of similar computing devices. Thus, for example, someone in their 20s living in an urban area who seem to frequent a set of urbanized locations and is interested in fashion may be associated with a profile for similarly situated individuals, while a 60-year-old person living in a rural area and interested in “kitchen gardens” may be associated with a profile for a different set of individuals. Next at operation 440, the UE 280 may select an initial set of accessible interactive features based on this associated profile. In various embodiments, the initial set of accessible interactive features may be based on an assumed level of interactive facility for the user, based on the profile. In various embodiments the initial set of accessible interactive features may also be based on the user's interests, such that features that are of particular use to someone with the user's interests are made available. Finally, at operation 450, the UE 280 may modify the access based on the user's knowledge or skill as determined at operation 410. Thus, if the user faces a particularly difficult time using the computing device, certain features may not be made available immediately despite the user's associated profile. Conversely, if the user is particular adept at using the computing device, or has substantial experience, additional interactive features may be made available. The process may then end.

FIG. 5 illustrates an example process 500 for determining a level of user facility, in accordance with various embodiments. Process 500 may include one or more implementations of operation 320 of process 300. While FIG. 5 illustrates particular operations in a particular order, in various embodiments the operations may be combined, split into parts, and/or omitted. In various embodiments, operations of process 500 may be performed by the computing device 100 as well as modules described herein, including the FD 260. In other embodiments, operations may be performed by different entities. The process may begin at operation 510, where the FD 260 may observe user interactions with the computing device. In various embodiments, these user interactions may include, but are not limited to, touch-based interactions with the computing device 100, voice interactions with the computing device 100, text input to the computing device 100, mouse-based interactions, etc. Next, at decision operation 515, the FD 260 may determine whether the user has made an explicit request for particular access. In some embodiments such an explicit request may include a request for a particular interactive feature, such as when a user requests access to an application that not installed (or is not available) on the computing device 100. In other embodiments, such an explicit request may include a request to revert access on the computing device 100 to an earlier snapshot of a set of interactive features. Such a request may be made, in some scenarios, if the user is not comfortable with a current set of interactive features and wishes that the computing device 100 were in an earlier state that was more comfortable to the user. If the user makes an explicit request, then at operation 520, the FD 260 may modify a determined level of interactive facility to accommodate the explicit request. The process may then end.

If, however, there is no explicit request, then at decision operation 525, the FD 260 may determine if any of the user interactions indicate an implicit request for access to an interactive feature. For example, if the user is performing a search for how to access sports scores on a browser (or help function) of the computing device, the FD 260 may determine that the user wishes to have access to sports information, but may not know to do so explicitly. In another embodiment, if the user performs a series of actions that may be performed by an interactive feature that is not currently available, the FD 260 may determine that the user wishes to have access to such an interactive feature. If so, then at operation 520, the FD 260 may modify a determined level of interactive facility to accommodate the implicit request. The process may then end.

If, however, no implicit request is indicated, then at operation 530, the FD 260 may determine a comfort level of the user with the computing device 100. In various embodiments the FD 260 may determine a comfort level based on various interactions observed, such as undo commands, repetition of interactions, pauses, searches in help files or help utilities, etc. In various embodiments, the FD 260 may determine a comfort level by analyzing audio received from the microphone 210 to measure frustration or discontent of the user using the computing device 100. In various embodiments, the FD 260 may determine a comfort level by analyzing video or image data received from the one or more camera(s) 220 to measure negative emotions and frustration exhibited on the faces of users using the computing device 100. In various embodiments, the FD 260 may also determine a comfort level by analyzing contacts by the user to other individuals, such as when the user contacts friends or other technology savvy individuals to request help with using the computing device 100.

If the comfort level is high, then at operation 550, the FD 260 may move to a higher level of interactive facility. In various embodiments, this higher level may be associated with a pre-determined path that is itself associated with the profile. Conversely, if the comfort level is low, then at operation 560 the FD 260 may move to a lower level of interactive facility. In various embodiments, this lower level may be associated with a pre-determined path that is itself associated with the profile. In either event, in some embodiments, the FD 260 may additionally modify profiles for similarly-situated persons to the user based on the successes or difficulties the user is experiencing. Thus, as users continuously utilize computing devices 100 and interactive features are provided at different points, profiles for other similar users may be modified, as well as paths to providing access for these users. Additionally, in either event, at operation 560, the FD may record a snapshot of a level of interactive facility. In various embodiments, such a snapshot may allow for later reversion by a user, such as at operations 515 and 520. The process may then end.

FIG. 6 illustrates an example process for providing access to features in accordance with various embodiments. Process 600 may include one or more implementations of operation 330 of process 300. While FIG. 6 illustrates particular operations in a particular order, in various embodiments the operations may be combined, split into parts, and/or omitted. In various embodiments, operations of process 600 may be performed by the computing device 100 as well as modules described herein, including the AP 270. In other embodiments, operations may be performed by different entities. The process may begin at operation 610, where the AP 260 may determine one or more interactive features to provide access to. In some embodiments these interactive features may be identified by reference to a path of predetermined interactive features associated with a profile. In other embodiments, the one or more interactive features may be determined based on an explicit or implicit request, as discussed above. In various embodiments, the determined one or more access features may be more or fewer features than were previously made available, such as depending on whether the user was requesting a few feature, reverting to a snapshot, or moving up or down a path. Next, at operation 620, the AP 270 may modify access by the user to provide access to the feature. In various embodiments, operation 620 may include installation or unlocking of an interactive feature.

Next, at operation 630, the AP 270 may indicate the change in access to the user. In various embodiments, as describe above, such indication may include, but is not limited to, visual elements, text announcements, sound announcements, etc. In some embodiments, the computing device 100 may, at operation 630, also show help screens or tutorials to the user. In various embodiments, the AP 470 may display short video clips, screenshots, text, or other educational tools to help educate the user (and potentially improve their comfort level). In various embodiments, these educational techniques may be utilized when a user moves to a lower level of facility (such as when a user does not appear to understand how to use an interactive feature) or to a higher level of facility (such as when a user is provided access to a new interactive feature but may not know how to use it). In various embodiments, the PA 270 may be configured to determine when the user is in a distractable state (such as looking at and using the device, but not actively engaged in an intensive activity) and to present these educational tools when the user is in this state.

Next, at operation 635, the AP 270 may determine whether all interactive features for the computing device 100 are accessible after the modification. If not, the process may end. If so, then at operation 640, the AP 270 may announce that all interactive features are now accessible, and that further selective access to interactive features will be ceased due to the now-complete access. The process may then end.

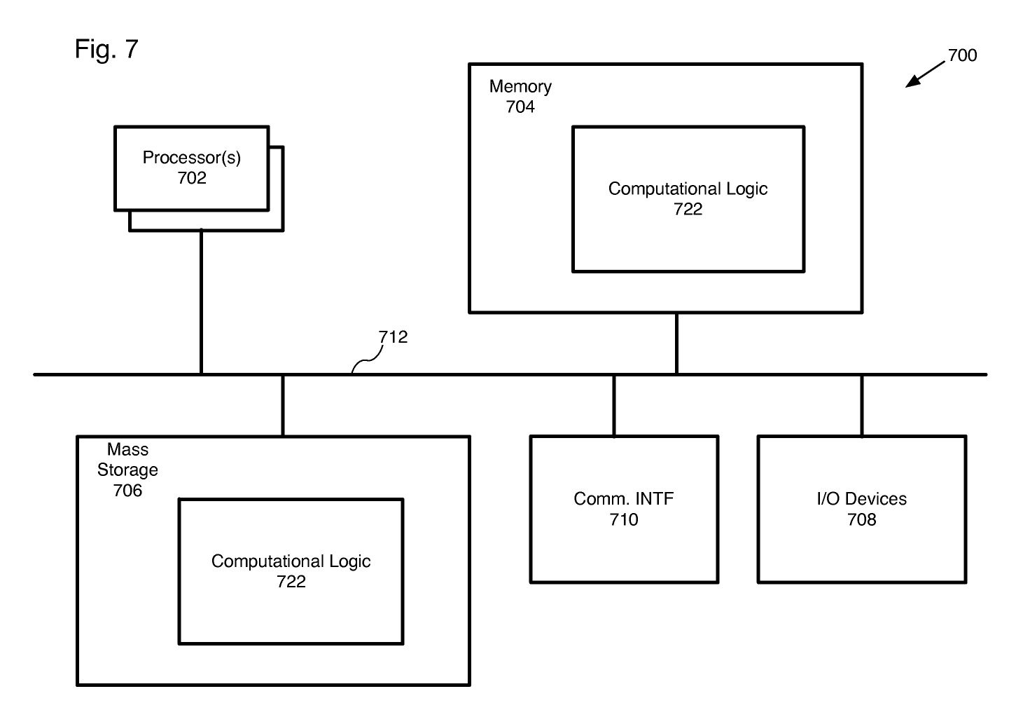

Referring now to FIG. 7, an example computer suitable for practicing various aspects of the present disclosure, including processes of FIGS. 3-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth, WiFi, Near Field Communications, Radio-frequency identification, and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing one or more of the modules or activities shown in FIGS. 1 and 2, and/or the operations associated with techniques shown in FIGS. 3-6, collectively referred to as computing logic 722. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 710-712 may vary. Their constitutions are otherwise known, and accordingly will not be further described.

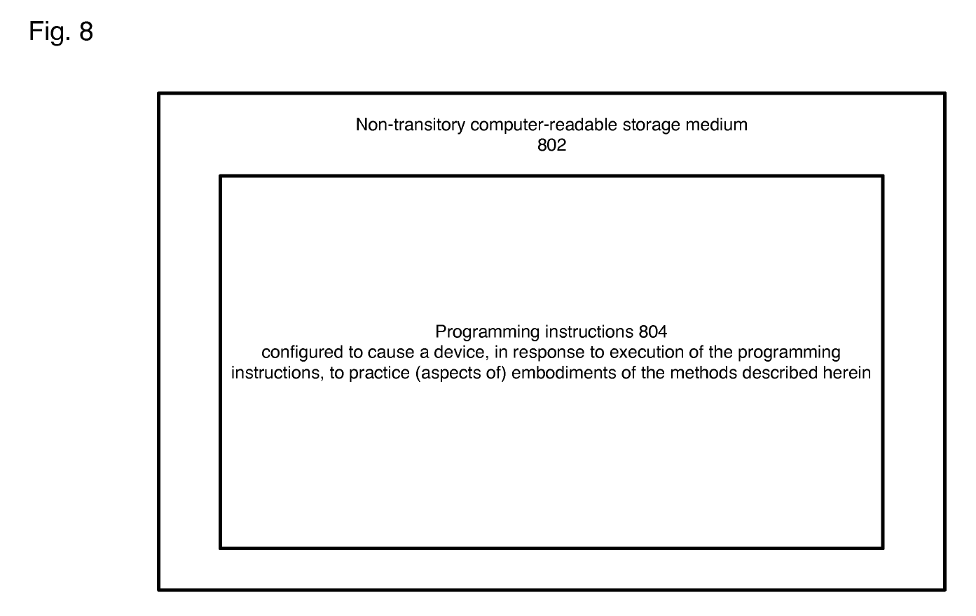

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 3-6, e.g., but not limited to, to the various operations performed to perform selective provision of access to interactive features. In alternate embodiments, programming instructions 804 may be disposed on multiple least one computer-readable storage media 802 instead.

Referring back to FIG. 7, for one embodiment, at least one of processors 702 may be packaged together with computational logic 722 configured to practice aspects of processes of FIGS. 3-6. For one embodiment, at least one of processors 702 may be packaged together with computational logic 722 configured to practice aspects of processes of FIGS. 3-6 to form a System in Package (SiP). For one embodiment, at least one of processors 702 may be integrated on the same die with computational logic 722 configured to practice aspects of processes of FIGS. 3-6. For one embodiment, at least one of processors 702 may be packaged together with computational logic 722 configured to practice aspects of processes of FIGS. 3-6 to form a System on Chip (SoC). For at least one embodiment, the SoC may be utilized in, e.g., but not limited to, a computing tablet. (e.g., WiFi, Blue Tooth, Blue Tooth Low Energy, Near Field Communications, Radio-frequency identification (RFID), etc.) and other components as necessary to meet functional and non-functional requirements of the system.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques. Particular examples of embodiments, described herein include, but are not limited to, the following:

Example 1 includes an apparatus with variable feature interactivity. The apparatus includes one or more computing processors and one or more application modules to be operated by the one or more computing processors to provide one or more interactive features to users of the apparatus. The apparatus also includes a facility determination module, to be operated by the one or more computing processors to determine a level of interactive facility associated with a user of the apparatus. The apparatus also includes an access provision module to selectively provide access to the user to one or more interactive features of the one or more application modules based on the determined level of interactive facility.

Example 2 includes the apparatus of example 1, wherein the apparatus further includes a user evaluation module to be operated by the one or more computing processors to evaluate the user to determine an initial level of interactive facility and the access provision module is, subsequent to operation of the initial facility determination module, to selectively provide access to the user the one or more interactive features based on the determined initial level of interactive facility.

Example 3 includes the apparatus of example 2, wherein the user evaluation module is further to be operated to evaluate the user through one or more requests for demographic or sociological information from the user.

Example 4 includes the apparatus of example 2, wherein the user evaluation module is further to evaluate the user through one or more requests of the user's comfort or experience level with interactive features of the one or more application modules.

Example 5 includes the apparatus of any of the above apparatus examples, wherein the facility determination module is to determine a level of interactive facility based on a request to access a feature by the user.

Example 6 includes the apparatus of any of the above apparatus examples, wherein the facility determination module is to determine a level of interactive facility based on one or more search terms entered by the user.

Example 7 includes the apparatus of any of the above apparatus examples, wherein the facility determination module is to determine a level of interactive facility includes that the facility determination module is to determine that the user has successfully used the apparatus at a first level of interactive facility over a period of time and to determine a second level of interactive facility, more advanced than the first level of interactive facility for use of the apparatus by the user.

Example 8 includes the apparatus of any of the above apparatus examples, wherein the facility determination module is to determine a level of interactive facility includes that the facility determination module is to select a level of interactive facility from a predetermined ordering of levels.

Example 9 includes the apparatus of example 8, wherein the facility determination module is to be operated to select the ordering based on demographic, sociologic, or interest information about the user and/or learning behavior of the user.

Example 10 includes the apparatus of any of the above apparatus examples, wherein the facility determination module is to determine a level of interactive facility based on a profile of the user.

Example 11 includes the apparatus of example 10, wherein the facility determination module is to utilize different profiles for different users of the apparatus.

Example 12 includes the apparatus of any of the above apparatus examples, wherein the access provision module is to selectively provide access to the user to one or more interactive features includes that the access provision module is to hide visible access to one or more interactive features of the one or more application modules.

Example 13 includes the apparatus of any of the above apparatus examples, wherein the access provision module is to selectively provide access to the user to one or more interactive features includes that the interaction moderation module is to determine an interactive feature for which the user has not previously been given access and to indicate the interactive feature to the user prior to granting access.

Example 14 includes one or more computer-readable media containing instructions written thereon that, in response to execution on a computing device, facilitate variable feature interactivity on the computing device. The instructions are to cause the computing device to determine level of interactive facility associated with a user of the computing device and selectively provide access to the user to one or more interactive features of one or more application modules operated on the computing device, the selectively providing being based on the determined level of interactive facility.

Example 15 includes the one or more computer-readable media of example 14, wherein the instructions are further to cause the computing device to evaluate the user to determine an initial level of interactive facility and selectively provide access to the user the one or more interactive features includes selectively provide access based on the determined initial level of interactive facility.

Example 16 includes the one or more computer-readable media of example 15, wherein evaluate the user includes perform one or more requests for demographic or sociological information from the user.

Example 17 includes the one or more computer-readable media of example 15, wherein evaluate the user includes evaluate the user through one or more requests of the user's comfort or experience level with interactive features of the one or more application modules.

Example 18 includes the one or more computer-readable media of any of the above computer-readable media examples, wherein determine a level of interactive facility includes receive a request to access a feature by the user.

Example 19 includes the one or more computer-readable media of any of the above computer-readable media examples, wherein determine a level of interactive facility includes analyze one or more search terms entered by the user.

Example 20 includes the one or more computer-readable media of any of the above computer-readable media examples, wherein determine a level of interactive facility includes determine that the user has successfully used the computing device at a first level of interactive facility over a period of time and determine a second level of interactive facility, more advanced than the first level of interactive facility for use of the computing device by the user.

Example 21 includes the one or more computer-readable media of any of the above computer-readable media examples, wherein determine a level of interactive facility includes select a level of interactive facility from a predetermined ordering of levels.

Example 22 includes the one or more computer-readable media of example 21, wherein select the ordering includes select the ordering based on demographic, sociologic, or interest information about the user and/or learning behavior of the user.

Example 23 includes the one or more computer-readable media of any of the above computer-readable media examples, wherein determine a level of interactive facility includes determine a level of interactive facility based on a profile of the user.

Example 24 includes the one or more computer-readable media of example 23, wherein determine a level of interactive facility based on a profile of the user includes utilize different profiles for different users of the computing device.

Example 25 includes the one or more computer-readable media of any of the above computer-readable media examples, wherein selectively provide access to the user includes hide visible access to one or more interactive features of the one or more application modules.

Example 26 includes tone or more computer-readable media of any of the above computer-readable media examples, wherein selectively provide access to the user includes determine an interactive feature for which the user has not previously been given access and indicate the interactive feature to the user prior to granting access.

Example 27 includes a method for facilitating variable feature interactivity in a computing device. The method includes determining, by a facility determination module operated on the computing device, a level of interactive facility associated with a user of the computing device and selectively providing, by an access provision module operated on the computing device, access to the user to one or more interactive features of one or more application modules operated on the computing device, the selectively providing being based on the determined level of interactive facility.

Example 28 includes the method of example 27, wherein the method further includes evaluating, by a user evaluation module operated on the computing device, the user to determine an initial level of interactive facility and selectively providing access to the user the one or more interactive features includes selectively providing access based on the determined initial level of interactive facility.

Example 29 includes the method of example 28, wherein evaluating the user includes performing one or more requests for demographic or sociological information from the user.

Example 30 includes the method of example 28, wherein evaluating the user includes evaluating the user through one or more requests of the user's comfort or experience level with interactive features of the one or more application modules.

Example 31 includes the method of any of the above method examples, wherein determining a level of interactive facility includes receiving a request to access a feature by the user.

Example 32 includes the method of any of the above method examples, wherein determining a level of interactive facility includes analyzing one or more search terms entered by the user.

Example 33 includes the method of any of the above method examples, wherein determining a level of interactive facility includes determining that the user has successfully used the computing device at a first level of interactive facility over a period of time and determining a second level of interactive facility, more advanced than the first level of interactive facility for use of the computing device by the user.

Example 34 includes the method of any of the above method examples, wherein determining a level of interactive facility includes selecting a level of interactive facility from a predetermined ordering of levels.

Example 35 includes the method of example 34, wherein selecting the ordering includes selecting the ordering based on demographic, sociologic, or interest information about the user and/or learning behavior of the user.

Example 36 includes the method of any of the above method examples, wherein determining a level of interactive facility includes determining a level of interactive facility based on a profile of the user.

Example 37 includes the method of example 36, wherein determining a level of interactive facility based on a profile of the user includes utilizing different profiles for different users of the computing device.

Example 38 includes the method of any of the above method examples, wherein selectively providing access to the user includes hiding visible access to one or more interactive features of the one or more application modules.

Example 39 includes the method of any of the above method examples, wherein selectively providing access to the user includes determining an interactive feature for which the user has not previously been given access and indicating the interactive feature to the user prior to granting access.

Example 40 includes an apparatus with variable feature interactivity. The apparatus includes means for determining a level of interactive facility associated with a user of the apparatus and means for selectively providing access to the user to one or more interactive features of one or more application modules operated on the apparatus, the selectively providing being based on the determined level of interactive facility.

Example 41 includes the apparatus of example 40, wherein the apparatus further includes means for evaluating the user to determine an initial level of interactive facility and means for selectively providing access to the user the one or more interactive features includes means for selectively providing access based on the determined initial level of interactive facility.

Example 42 includes the apparatus of example 41, wherein means for evaluating the user includes means for performing one or more requests for demographic or sociological information from the user.

Example 43 includes the apparatus of example 41, wherein means for evaluating the user includes means for evaluating the user through one or more requests of the user's comfort or experience level with interactive features of the one or more application modules.

Example 44 includes the apparatus of any of the above apparatus examples, wherein means for determining a level of interactive facility includes means for receiving a request to access a feature by the user.

Example 45 includes the apparatus of any of the above apparatus examples, wherein means for determining a level of interactive facility includes means for analyzing one or more search terms entered by the user.

Example 46 includes the apparatus of any of the above apparatus examples, wherein means for determining a level of interactive facility includes means for determining that the user has successfully used the apparatus at a first level of interactive facility over a period of time and means for determining a second level of interactive facility, more advanced than the first level of interactive facility for use of the apparatus by the user.

Example 47 includes the apparatus of any of the above apparatus examples, wherein means for determining a level of interactive facility includes means for selecting a level of interactive facility from a predetermined ordering of levels.

Example 48 includes the apparatus of example 47, wherein means for selecting the ordering includes means for selecting the ordering based on demographic, sociologic, or interest information about the user and/or learning behavior of the user.

Example 49 includes the apparatus of any of the above apparatus examples, wherein means for determining a level of interactive facility includes means for determining a level of interactive facility based on a profile of the user.

Example 50 includes the apparatus of example 49, wherein means for determining a level of interactive facility based on a profile of the user includes means for utilizing different profiles for different users of the apparatus.

Example 51 includes the apparatus of any of the above apparatus examples, wherein means for selectively providing access to the user includes means for hiding visible access to one or more interactive features of the one or more application modules.

Example 52 includes the apparatus of any of the above apparatus examples, wherein means for selectively providing access to the user includes means for determining an interactive feature for which the user has not previously been given access and means for indicating the interactive feature to the user prior to granting access.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus, comprising:
one or more computing processors;
one or more application modules to be operated by the one or more computing processors to provide one or more interactive features to users of the apparatus; and
a facility determination module, to be operated by the one or more computing processors to determine a level of interactive facility associated with a user of the apparatus; and
an access provision module to selectively provide access to the user to one or more interactive features of the one or more application modules based on the determined level of interactive facility.

2. The apparatus of claim 1, wherein:
the apparatus further comprises a user evaluation module to be operated by the one or more computing processors to evaluate the user to determine an initial level of interactive facility; and
the access provision module is, subsequent to operation of the initial facility determination module, to selectively provide access to the user the one or more interactive features based on the determined initial level of interactive facility.

3. The apparatus of claim 2, wherein the user evaluation module is further to be operated to evaluate the user through one or more requests for demographic or sociological information from the user.

4. The apparatus of claim 2, wherein the user evaluation module is further to evaluate the user through one or more requests of the user's comfort or experience level with interactive features of the one or more application modules.

5. The apparatus of claim 1, wherein the facility determination module is to determine a level of interactive facility based on a request to access a feature by the user.

6. The apparatus of claim 1, wherein the facility determination module is to determine a level of interactive facility based on one or more search terms entered by the user.

7. The apparatus of claim 1, wherein the facility determination module is to determine a level of interactive facility comprises that the facility determination module is to:
determine that the user has successfully used the apparatus at a first level of interactive facility over a period of time; and
determine a second level of interactive facility, more advanced than the first level of interactive facility for use of the apparatus by the user.

8. The apparatus of claim 1, wherein the facility determination module is to determine a level of interactive facility comprises that the facility determination module is to select a level of interactive facility from a predetermined ordering of levels.

9. The apparatus of claim 8, wherein the facility determination module is to be operated to select the ordering based on demographic, sociologic, or interest information about the user and/or learning behavior of the user.

10. The apparatus of claim 1, wherein the facility determination module is to determine a level of interactive facility based on a profile of the user.

11. The apparatus of claim 10, wherein the facility determination module is to utilize different profiles for different users of the apparatus.

12. The apparatus of claim 1, wherein the access provision module is to selectively provide access to the user to one or more interactive features comprises that the access provision module is to hide visible access to one or more interactive features of the one or more application modules.

13. The apparatus of any of claim 1, wherein the access provision module is to selectively provide access to the user to one or more interactive features comprises that the interaction moderation module is to:
determine an interactive feature for which the user has not previously been given access; and
indicate the interactive feature to the user prior to granting access.

14. One or more computer-readable media containing instructions written thereon that, in response to execution on a computing device, cause the computing device to:
determine level of interactive facility associated with a user of the computing device; and
selectively provide access to the user to one or more interactive features of one or more application modules operated on the computing device, the selectively providing being based on the determined level of interactive facility.

15. The one or more computer-readable media of claim 14, wherein:
the instructions are further to cause the computing device to evaluate the user to determine an initial level of interactive facility; and
selectively provide access to the user the one or more interactive features comprises selectively provide access based on the determined initial level of interactive facility.

16. The one or more computer-readable media of claim 15, wherein evaluate the user comprises at least one of perform one or more requests for demographic or sociological information from the user or evaluate the user through one or more requests of the user's comfort or experience level with interactive features of the one or more application modules.

17. The one or more computer-readable media of claim 14, wherein determine a level of interactive facility comprises:
determine that the user has successfully used the computing device at a first level of interactive facility over a period of time; and
determine a second level of interactive facility, more advanced than the first level of interactive facility for use of the computing device by the user.

18. The one or more computer-readable media of claim 14, wherein determine a level of interactive facility comprises select a level of interactive facility from a predetermined ordering of levels, based on demographic, sociologic, or interest information about the user and/or learning behavior of the user.

19. The one or more computer-readable media of claim 14, wherein selectively provide access to the user comprises hide visible access to one or more interactive features of the one or more application modules.

20. The one or more computer-readable media of claim 14, wherein selectively provide access to the user comprises:
determine an interactive feature for which the user has not previously been given access; and
indicate the interactive feature to the user prior to granting access.

21. A method, comprising:
determining, by a facility determination module operated on the computing device, a level of interactive facility associated with a user of the computing device; and
selectively providing, by an access provision module operated on the computing device, access to the user to one or more interactive features of one or more application modules operated on the computing device, the selectively providing being based on the determined level of interactive facility.

22. The method of claim 21, wherein:
the method further comprises evaluating, by a user evaluation module operated on the computing device, the user to determine an initial level of interactive facility; and
selectively providing access to the user the one or more interactive features comprises selectively providing access based on the determined initial level of interactive facility.

23. The method of claim 21, wherein determining a level of interactive facility comprises:
determining that the user has successfully used the computing device at a first level of interactive facility over a period of time; and
determining a second level of interactive facility, more advanced than the first level of interactive facility for use of the computing device by the user.

24. The method of claim 21, wherein selectively providing access to the user comprises hiding visible access to one or more interactive features of the one or more application modules.

25. The method of claim 21, wherein selectively providing access to the user comprises:
determining an interactive feature for which the user has not previously been given access; and
indicating the interactive feature to the user prior to granting access.
